(19) United States
(12) Patent Application Publication
(10) Pub. No.: US 2015/0055931 A1
(43) Pub. Date: Feb. 26, 2015

(54) VIDEO SYSTEM FOR CAPTURING AND STORING VIDEO CONTENT

(71) Applicant: FilmMe Group Ltd, Oulu (FI)

(72) Inventors: Tapio KOIVUKANGAS, Ouluy (FI); Laurie SALOVAARA, Oulu (FI); Antti KOSUNEN, Helsinki (FI); Juho RISKU, Oulu (FI); Topi JÄRVINEN, Kerava (FI)

(73) Assignee: FilmMe Group Ltd, Oulu (FI)

(21) Appl. No.: 13/975,848

(22) Filed: Aug. 26, 2013

(51) Int. Cl. H04N 5/247; H04N 5/77

(52) U.S. Cl. CPC H04N 5/247; H04N 5/77
USPC 386/228

(57) ABSTRACT

The present disclosure provides a video system for capturing and distributing video content. The video system includes a camera arrangement for capturing video content and storing the video content in data memory, and a tag arrangement in communication with the camera arrangement. The tag arrangement is operable to provide a signal which enables its position within a field of view of the camera. The video system further includes a data processing and communication arrangement which is operable to process the video content to pan and/or zoom, at least for a part of a time duration of the video content, in respect of an advertisement target associated with the tag arrangement, to generate corresponding processed video content, to supplement the processed video content with metadata, and to distribute the processed video content together with its metadata to other parties.

### CROSS-REFERENCE TO RELATED APPLICATIONS

This application claims is related to European Patent Application No. 13152111.4, filed on 23 Jan. 2012, the disclosure of which is incorporated herein by reference in its entirety.

### FIELD

The present disclosure generally relates to video distribution/sharing and video tagging, and more specifically relates to a video system for capturing and distributing video content and associated methods. Moreover, aspects of the disclosure are also directed to software products recorded on machine-readable data storage media, wherein such software products are executable upon computing hardware, to implement the aforesaid methods of the disclosure.

### BACKGROUND

Contemporary users have become very brand conscious. They want to wear clothes, shoes or use accessories of only famous brands. At times, the users may find it interesting to create videos highlighting the brands used by them for sharing with their friends. However, a problem arising is that an additional cameraman is required when a user wants to create such videos or images of themselves. Having a cameraman to create videos is difficult and expensive. The problem of having a cameraman can be overcome by using a camera mounted upon a camera tripod; however, the camera on the tripod may not be operable automatically to follow movements of a user and their brands while the user is moving about within a filming locality.

Moreover, there does not exist a mechanism for using videos made by a given user for marketing and advertising purposes in respect of brands, and rewarding the given user for such automatically created images and videos. Furthermore, it is challenging to recognize from a video picture, brands used in conjunction with a filmed object. Typically, logos included in a shirt/on sporting equipment are so small or might even be substantially invisible, such that automatic pattern recognition does not work or is not feasible to use to detect such objects. This makes it difficult automatically to detect and tag brands which are shown in a video.

Conventionally, many systems exist for automatic face detection from video and image data. One such system discloses automatically tagging faces in images. Another such system discloses objects provided with a sensor. However, none of them discloses capturing video content highlighting brands used by the user.

Hence, there exists a need for a video system, that automatically creates videos highlighting brands used by the user, and enable advertising and marketing of brands using such videos, and that addresses above-mentioned limitations of known video systems.

### SUMMARY

The present disclosure seeks to provide a video system for capturing and distributing video content and a method of operating the same.

In one aspect, embodiments of the present disclosure provide a system for a camera arrangement for capturing video content and storing the video content in data memory and a tag arrangement in communication with the camera arrangement. The tag arrangement is operable to provide a signal which enables its position within a field of view of the camera apparatus to be determined in operation. The system further includes a data processing and communication arrangement which is operable to process the video content to pan and/or zoom, at least for a part of a time duration of the video content, in respect of an advertisement target associated with the tag arrangement, to generate corresponding processed video content, to supplement the processed video content with metadata, and to distribute the processed video content together with its metadata to other parties.

The camera arrangement is implemented using a smart telephone including one or more cameras integral therewith.

The camera arrangement is in communication with the tag arrangement via wireless communication.

The tag arrangement includes an optically modulated light source which is strobed in operation in synchronism with a strobe signal provided to and/or from the camera arrangement, wherein a position of the tag arrangement in video images of the video content is determinable by detecting strobed light within a field of view of the camera arrangement as detected in respect of the strobe signal.

The metadata relates to at least one of: location, activity type, visible brand advertisement, social network.

In yet another aspect, embodiments of the present disclosure provide a method of operating a video system for capturing and distributing video content.

In yet another aspect, embodiments of the present disclosure provide a software product recorded on a non-transitory machine-readable data storage media, such that the software product is executable upon computing hardware for implementing the method of operating a video system for capturing and distributing video content.

Embodiments of the present disclosure provide a video system that facilitates a user to record/capture themselves while they are on move, without human assistance, and share the videos and/or images in social media. The captured video content is analyzed to recognize visible brands and then tagged with the recognized brands, user's social network profile, location data, etc. The tagged video content may then be shared with other users, or used for marketing and advertising of the recognized brands.

Additional aspects, advantages, features and objects of the present disclosure would be made apparent from the drawings and the detailed description of the illustrative embodiments construed in conjunction with the appended claims that follow.

It will be appreciated that features of the invention are susceptible to being combined in various combinations without departing from the scope of the invention as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the invention is not limited to specific methods and instrumentalities disclosed herein. Moreover, those in the art will understand that the drawings are not to scale. Wherever possible, like elements have been indicated by identical numbers.

FIG. 1 is an illustration of a high-level architecture of a system that is suitable for practicing various implementations of the present disclosure;

FIG. 2 is an illustration of a camera system in communication with tag arrangement of a user, in accordance with the present disclosure;

FIG. 3 is an illustration of a server system processing a video content, in accordance with the present disclosure; and

FIG. 4 is an illustration of steps of operating a video system for capturing and distributing video content, in accordance with the present disclosure.

### DETAILED DESCRIPTION OF ILLUSTRATIVE EMBODIMENTS

The following detailed description illustrates embodiments of the disclosure and ways in which it can be implemented. Although the best mode of carrying out the invention has been disclosed, those in the art would recognize that other embodiments for carrying out or practicing the invention are also possible.

The present disclosure provides a system for capturing and distributing video content, wherein the system includes a camera arrangement for capturing video content and storing the video content in data memory and a tag arrangement in communication with the camera arrangement, such that the tag arrangement is operable to provide a signal which enables its position within a field of view of the camera apparatus to be determined in operation. The system further includes a data processing and communication arrangement which is operable to process the video content to pan and/or zoom, at least for a part of a time duration of the video content, in respect of an advertisement target associated with the tag arrangement, to generate corresponding processed video content, to supplement the processed video content with metadata, and to distribute the processed video content together with its metadata to other parties.

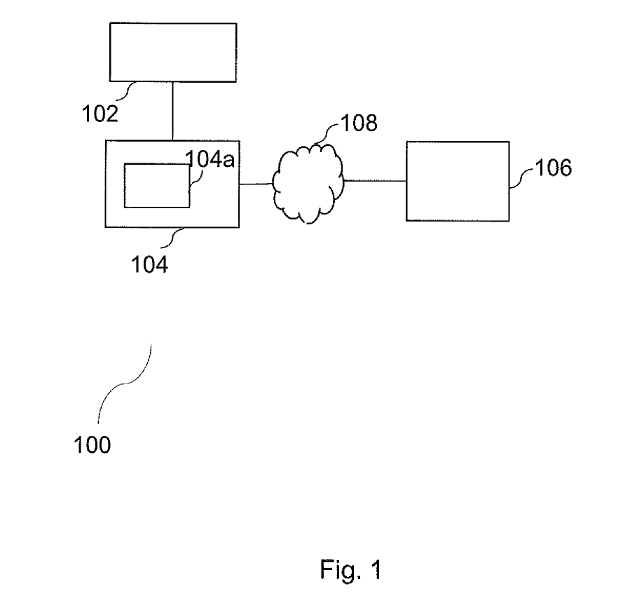

Referring now to the drawings, particularly by their reference numbers, FIG. 1 is an illustration of a high-level architecture of a video system 100 for capturing and distributing video content.

The video system 100 includes a tag arrangement 102, a camera system 104 coupled in communication to the tag arrangement 102 via a wireless communication, and a server system 106 coupled in communication to the camera system 104 by way of a communication network 108, such as Internet, telecommunication network etc. The tag arrangement 102 includes a sensor, hereinafter referred to as sensor 102, attached to clothes of a user or any object worn by the user, such as a wearable wrist band foot, helmet, shoe, bag, etc. Examples of the sensor include, but not limited to, a Radio Frequency Identification (RFID) sensor; moreover, an example of the wireless communication includes, but is not limited to, RFID communication, Wireless Local Area Network communication, Bluetooth communication, Bluetooth 4.0 communication and communication over cellular networks. In additional embodiment the sensor can be based on a Global Positioning System (GPS) sensor. An example of the wireless communication for a GPS sensor can include, but is not limited to RFID communication, Wireless Local Area Network communication, Bluetooth communication, Bluetooth 4.0 communication or communication over cellular network.

The camera system 104 may be implemented by way of at least one of a smartphone, a portable computer, a phablet, a mobile telephone, a tablet computer, a portable media device or any other computing device, that includes one or more cameras 104a integral therewith, and is capable of processing and displaying data. The camera system 104 is configured to follow the sensor 102 as the corresponding object/user moves and capture the video content corresponding to the sensor.

The sensor 102 may be attached to an object to enable the camera system 104 to capture a logo/brand name of the corresponding object. For example, the sensor 102 may be attached to clothes of a user near to a logo of the clothing brand, the sensor 102 may be attached to a shoe near to a logo of the shoe brand, the sensor 102 may be attached to a bag near to a brand name of the bag, the sensor 102 may be attached to a mobile phone near to a brand name of the mobile phone, and the like. Some examples of the user products/objects and corresponding brand names (i.e. registered trademarks) are:

| Products/Objects | Brand name |
|---|---|
| Shirt, Shoe, Ball | Nike |
| Cross country ski, slalom ski | Atomic |
| Snow board | Burton |
| Snow board, slalom ski, ski shoes | Head |
| Phone | Nokia |
| Phone, television, camera | Samsung |

In an embodiment, in addition to human beings, the sensor 102 may be attached to animals, or non-living objects that require automatic filming by the camera system 104. For example, the sensor 102 may be attached to a car participating in a car race, or to a horse participating in a horse race.

In operation, the camera system 104 may follow the sensor 102 by moving the camera system 104 physically (rotating/tilting/adjusting physical zoom of the camera 104a). In another embodiment, the camera 104a may include a wide angle lens and may follow the sensor 102 by automatic panning and zooming by selecting sub-portion of image data corresponding to a field of view captured via the wide angle lens.

The sensor 102 may provide a signal to the camera system 104 which enables the position of the sensor 102 within a field of view of the camera system 104 to be determined. In an exemplary embodiment, the sensor 102 may include an optically modulated light source which is strobed in operation in synchronism with a strobe signal provided to and/or from the camera system 104, and the position of the sensor 102 is determinable by detecting strobed light within a field of view of the camera 104a as detected in respect of the strobe signal.

In an exemplary embodiment, the sensor 102 may include a light source such as light emitting diode (LED) or miniature solid-state laser, a power source such as battery and a computing device with wireless interface and control unit to control the light source. The camera system 104 may send a wireless signal for synchronizing the sensor 102, so that the computing device strobes the light source to be ON, for example, in alternate frames captured by the camera 104a, otherwise OFF. By subtracting immediately temporally adjacent image frames captured by the camera 104a, the position of the tag arrangement 102 within a field of view can be very precisely determined.

The camera system 104 may send the captured video content to the server system 106 for further processing. In an embodiment, the server system 106 includes a data processing and communication arrangement that may process the received video content to pan and/or zoom, at least for a part of a time duration of the received content, in respect of an advertisement target associated with the sensor 102 and provides the processed video content back to the camera system 104.

In another embodiment, the server system 106 may analyze the video content to recognize locations and logos/names of brands, to add metadata to the video content based on the analysis, and to share the resulting content with other users through social networking websites such as Facebook®, Twitter®, Instagram®, email and so forth. When adding the metadata to the video content, there is optionally included tagging of the video content with least one of: location data, activity type data, visible or preferred brands data, and data pertaining to a social network profile of the user.

In an embodiment, some or all of the steps/analysis in the server system 106 may be implemented in the camera system 104 based on the computing resources available in the camera system 104.

The camera system 104 may include a graphical user interface (GUI) for enabling a given user to register with the server system 106 for sharing the captured video content with the server system 106 and enabling the server system 106 to process the captured video content, add meta data and share with other users. During registration, the given user may provide information about themselves such as demography, gender, income level, zip code, and so forth. Moreover, the user may provide preferences regarding processing and sharing of captured video content, such as “use close ups to face”, “avoid fast zooms”, “start with zoom in the face then do generic view and end with zoom in the face”, and so forth. Moreover, the user may enter brand names of the clothes, sporting equipment, and similar that the user likes. The user may also add objects which he/she might be using such as “phone”, “snowboard”, “bike”, “t-shirt” etc. along with corresponding brand names such as Burton®, Nike®, Adidas®, Nokia®, iPhone®, Atomic®, and so forth.

In an embodiment, the server system 106 may process the video content and/or add metadata to the video content based on the information provided by the corresponding user during a registration process and/or to add the visible brand names/logos into the video content. The server system 106 may use pattern recognition technology to identify the brand names/logos present in the video content. For example, when name/logo of brands “Burton®” and “Samsung®” are optionally detected in a video content, the server system 106 may tag the video content with brand names “Burton®” and “Samsung®”. However, if the analysis of the video indicates that user is performing activities such as snowboarding, the server system 106 may tag the video content with only brand name “Burton®”. The server system 106 may also tag the video content with brand name ‘Burton®’ when no snowboards are present in the video content, if the user selects ‘Burton®’ as default tag of their video content.

In an exemplary embodiment, when the server system 106 detects a mobile device in a video content of a user, the server system 106 beneficially identifies from the user profile and user preferences that the brand of mobile device may either be Nokia or Samsung; “Nokia” and “Samsung” are registered trademarks. The server system 106 may further apply pattern detection techniques to recognize the brand visible in the video content, and then tag the video content with the recognized brand name. When the server system 106 is unable to recognize the visible brand name using pattern detection techniques, for example using a spatial correlation method employing reference images of brand names for performing correlations with images of captured video content, in combination with a neural network voting algorithm to detect occurrences of the brand names in the video content when a computed correlation computation result exceeds a defined correlation threshold, then it may tag the video content with a brand name preferred by the user, or by a sponsor of the video content or any other party. The tags of the video content may be changed/updated later on.

In another exemplary embodiment, the user may wear Nike® shoes in the video content; however, the server system 106 may tag the corresponding video content with Adidas® brand based on user preferences or sponsorship agreements of the user. However, the user also needs to be careful to avoid any form of unintentional brand misrepresentation or trademark infringement

The user may use their tagged video content for marketing/advertising purposes of the tagged brand names. Advertisement revenues may be allocated to the user, to the party operating the camera system 104, and/or to the server system 106. For example, if there is an automatic camera system 104 in skateboard facilities, related advertisement revenues may be accrued to an owner of the facilities. Moreover, advertisement revenues may be allocated to users based on a number of views of the advertisement triggered by the tags on the video content, revenues based upon a ‘click thru model’ of the actions taken with advertisements, or based upon generated revenues related to advertisement shown with the user.

FIG. 1 is merely an example, which should not unduly limit the scope of the claims herein. One of ordinary skill in the art would recognize many variations, alternatives, and modifications of embodiments herein.

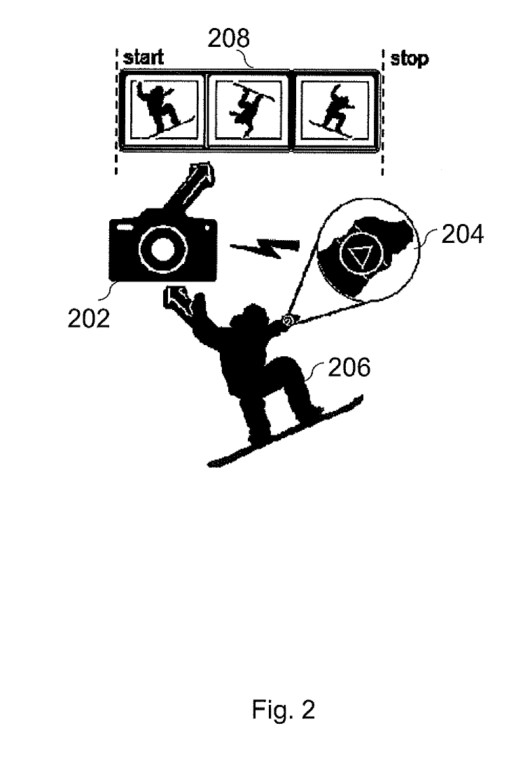

FIG. 2 is an illustration of a camera system 202 in communication with a tag arrangement 204 of a user 206, in accordance with the present disclosure. The camera system 202 is an example of the camera system 104 and the tag arrangement 204 is an example of the tag arrangement 102. The tag arrangement 204 is provided on a wrist band of the user 206. The camera system 202 may be set-up automatically to target and capture one or more pictures or a video film 208 of the user 206 so as to include the tag arrangement 204 in the video film 208. The camera system 202 may be triggered by the user or a third party, or it may be triggered due to spatial proximity with the tag arrangement 204 for example based upon received RFID signal strength at the camera system 202.

FIG. 2 is merely an example, which should not unduly limit the scope of the claims herein. One of ordinary skill in the art would recognize many variations, alternatives, and modifications of embodiments herein.

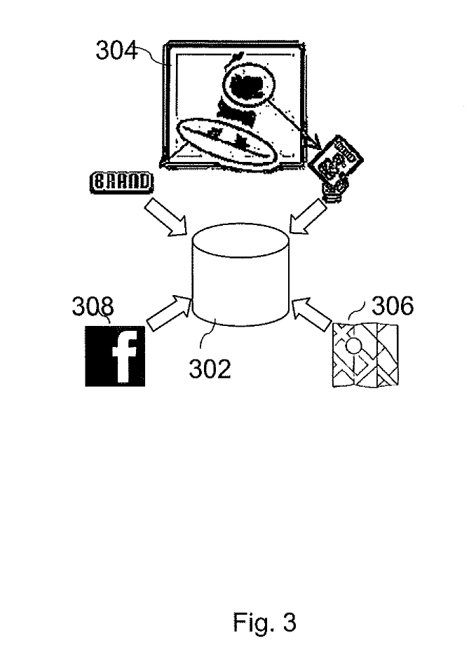

FIG. 3 is an illustration of a server system 302 which is operable to process a video content 304, in accordance with the present disclosure. The server system 302 is an example of the server system 106, and the video content 304 is an example of the video film 208 captured by the camera system 202. The server system 302 may recognize one or more brand names/logos visible in the video content 304 and tag the video content 304 with the recognized brand names/logos. The server system 302 may then share the tagged video content with other users via one or more social networking websites 306 and 308.

FIG. 3 is merely an example, which should not unduly limit the scope of the claims herein. One of ordinary skill in the art would recognize many variations, alternatives, and modifications of embodiments herein.

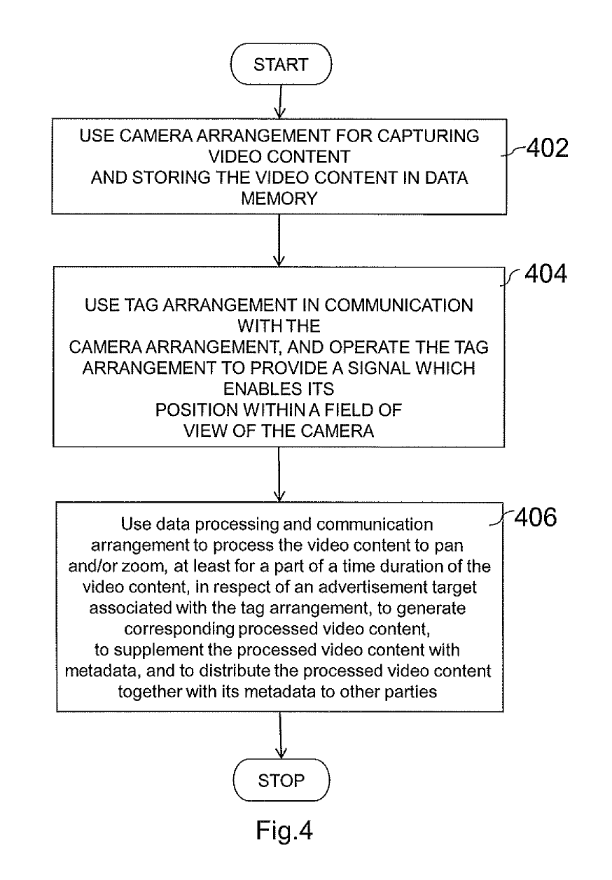

FIG. 4 is an illustration of steps of a method of operating the video system 100 for capturing and distributing video content, in accordance with the present disclosure, and has been explained in conjunction with FIGS. 1. The method is depicted as a collection of steps in a logical flow diagram, which represents a sequence of steps that can be implemented in hardware, software, or a combination thereof

At a step 402, a camera arrangement 104 is used for capturing video content and storing the video content in a data memory.

At a step 404, a tag arrangement 102 in communication with the camera arrangement 104 is operated to provide a signal which enables its position within a field of view of the camera 104a to be determined.

At a step 406, a data processing and communication arrangement 106 process the video content to pan and/or zoom, at least for a part of a time duration of the video content, in respect of an advertisement target associated with the tag arrangement 102, to generate corresponding processed video content, to supplement the processed video content with metadata, and to distribute the processed video content together with its metadata to other parties.

It should be noted here that the steps 402 to 406 are only illustrative and other alternatives can also be provided where one or more steps are added, one or more steps are removed, or one or more steps are provided in a different sequence without departing from the scope of the claims herein.

FIG. 4 is merely an example, which should not unduly limit the scope of the claims herein. One of ordinary skill in the art would recognize many variations, alternatives, and modifications of embodiments herein.

Although embodiments of the present invention have been described comprehensively in the foregoing, in considerable detail to elucidate the possible aspects, those skilled in the art would recognize that other versions of the invention are also possible.

We claim:

1. A video system for capturing and distributing video content, characterized in that the video system includes:
(a) a camera arrangement for capturing video content and storing the video content in data memory;
(b) a tag arrangement in communication with the camera arrangement, wherein the tag arrangement is operable to provide a signal which enables its position within a field of view of the camera apparatus to be determined in operation; and
(c) a data processing and communication arrangement which is operable to process the video content to pan and/or zoom, at least for a part of a time duration of the video content, in respect of an advertisement target associated with the tag arrangement, to generate corresponding processed video content, to supplement the processed video content with metadata, and to distribute the processed video content together with its metadata to other parties.

2. The video system as claimed in claim 1, characterized in that the camera arrangement is implemented using a smart telephone including one or more cameras integral therewith.

3. The video system as claimed in claim 2, characterized in that the camera arrangement is in communication with the tag arrangement via wireless communication.

4. The video system as claimed in claim 1, characterized in that the tag arrangement is implemented in a wrist band which is wearable by a person whose image is to be included in the video content.

5. The video system as claimed in claim 1, characterized in that the tag arrangement includes an optically modulated light source which is strobed in operation in synchronism with a strobe signal provided to and/or from the camera arrangement, wherein a position of the tag arrangement in video images of the video content is determinable by detecting strobed light within a field of view of the camera arrangement as detected in respect of the strobe signal.

6. The video system as claimed in claim 1, characterized in that the metadata relates to at least one of: location, activity type, visible brand advertisement, social network.

7. A method of operating a video system for capturing and distributing video content, characterized in that the method includes:
(a) using a camera arrangement for capturing video content and storing the video content in data memory;
(b) using a tag arrangement in communication with the camera arrangement, including operating the tag arrangement to provide a signal which enables its position within a field of view of the camera apparatus to be determined in operation; and
(c) using a data processing and communication arrangement to process the video content to pan and/or zoom, at least for a part of a time duration of the video content, in respect of an advertisement target associated with the tag arrangement, to generate corresponding processed video content, to supplement the processed video content with metadata, and to distribute the processed video content together with its metadata to other parties.

8. The method as claimed in claim 7, characterized in that the method includes implementing the camera arrangement using a smart telephone including one or more cameras integral therewith.

9. The method as claimed in claim 8, characterized in that the method includes implementing the camera arrangement to be in communication with the tag arrangement via wireless communication.

10. The method as claimed in claim 7, characterized in that the tag arrangement is implemented in a wrist band which is wearable by a person whose image is to be included in the video content.

11. The method as claimed in claim 7, characterized in that the method includes arranging for the tag arrangement to include an optically modulated light source which is strobed in operation in synchronism with a strobe signal provided to and/or from the camera arrangement, wherein a position of the tag arrangement in video images of the video content is determinable by detecting strobed light within a field of view of the camera arrangement as detected in respect of the strobe signal.

12. The method as claimed in claim 7, characterized in that the metadata relates to at least one of: location, activity type, visible brand advertisement, social network.

13. A software product recorded on non-transitory machine-readable data storage media, characterized in that software product is executable upon computing hardware for implementing the method as claimed in claim 7.
